(19) United States
(12) Patent Application Publication
(10) Pub. No.: US 2023/0138035 A1
(43) Pub. Date: May 4, 2023

(54) TRANSACTION BASED FRAUD DETECTION

(71) Applicant: MX Technologies, Inc., Lehi, UT (US)

(72) Inventors: MICHAEL LOTT, Sandy, UT (US); DAVID WHITCOMB, Crozet, VA (US)

(73) Assignee: MX Technologies, Inc., Lehi, UT (US)

(21) Appl. No.: 17/978,184

(22) Filed: Oct. 31, 2022

Related U.S. Application Data
(60) Provisional application No. 63/274,002, filed on Oct. 31, 2021.

(51) Int. Cl. G06Q 20/40

(52) U.S. Cl. CPC G06Q 20/4016; G06Q 20/4014

(57) ABSTRACT

Apparatuses, methods, computer program products, and systems are disclosed for transaction based fraud detection. A method includes receiving, over an application programming interface, an electronic request to perform an action for a user. A method includes electronically accessing one or more attributes of an account for the user. A method includes selectively performing the action for the user based on the one or more attributes of the account.

### CROSS-REFERENCES TO RELATED APPLICATIONS

This application claims the benefit of U.S. Provisional Patent Application No. 63/274,002 entitled “TRANSACTION BASED FRAUD DETECTION” and filed on Oct. 31, 2021, for Michael Lott, et al., which is incorporated herein by reference in its entirety for all purposes.

### FIELD

This invention relates to fraud detection and more particularly relates to transaction and/or account based fraud detection.

### BACKGROUND

Verification of users and/or accounts can be an important tool in preventing fraud. However, verification is often slow, and limited to basic information such as name, address, government identification, or the like.

### BRIEF SUMMARY

Apparatuses, methods, computer program products, and systems are disclosed for transaction based fraud detection. In one embodiment, an apparatus includes a processor and a memory that stores code executable by the processor. Executable code, in some embodiments, is executable to receive, over an application programming interface, an electronic request to perform an action for a user. In a further embodiment, executable code is executable to electronically access one or more attributes of an account for the user. In certain embodiments, executable code is executable to selectively perform the action for the user based on the one or more attributes of the account.

In some embodiments, a method for transaction based fraud detection includes receiving, over an application programming interface, an electronic request to perform an action for a user. A method, in certain embodiments, includes electronically accessing one or more attributes of an account for the user. In a further embodiment, a method includes selectively performing the action for the user based on the one or more attributes of the account.

In one embodiment, an apparatus for transaction based fraud detection includes means for receiving, over an application programming interface, an electronic request to perform an action for a user. An apparatus, in some embodiments, includes means for electronically accessing one or more attributes of an account for the user. In certain embodiments, an apparatus includes means for selectively performing the action for the user based on the one or more attributes of the account.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a system for transaction based fraud detection;

FIG. 1B is a schematic block diagram illustrating one embodiment of a system for transaction based fraud detection;

FIG. 2 is a schematic block diagram of one embodiment of a verification module;

FIG. 3 is a schematic block diagram of another embodiment of a verification module;

FIG. 4 is a schematic flow chart diagram illustrating one embodiment of a method for transaction based fraud detection; and

FIG. 5 is a schematic flow chart diagram illustrating a further embodiment of a method for transaction based fraud detection.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

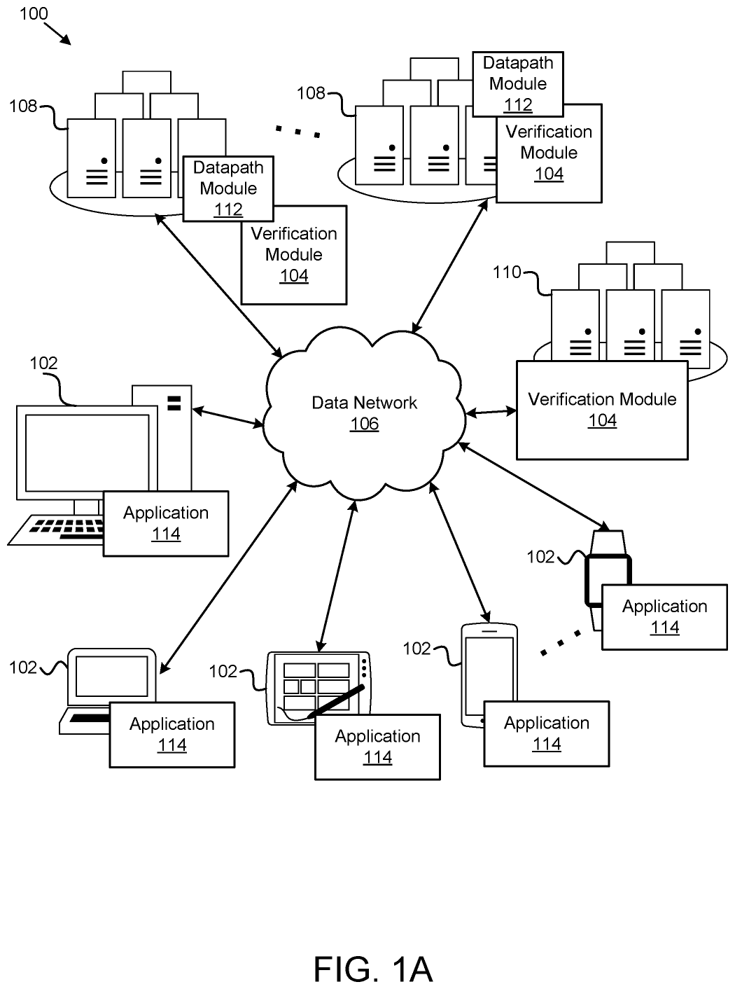

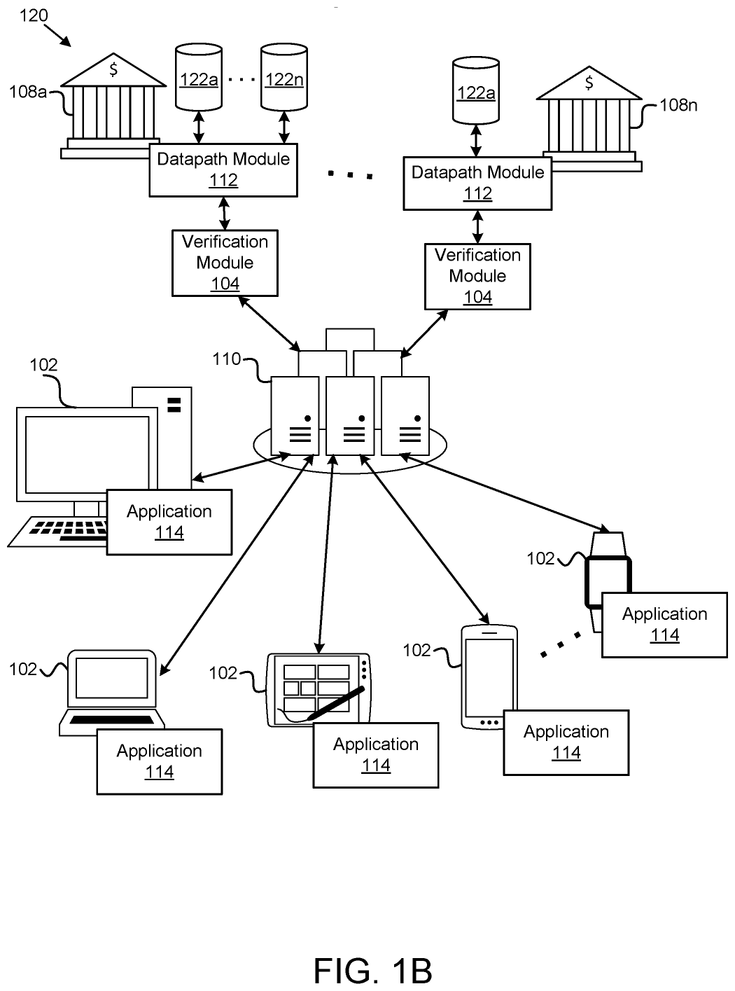

FIG. 1A and FIG. 1B depict embodiments of systems 100, 120 for transaction based fraud detection. In one embodiment, the system 100 includes one or more hardware computing devices 102, one or more verification modules 104 (e.g., a backend verification module 104 disposed on a backend server 110, and/or a plurality of verification modules 104 disposed on servers 108 of one or more third-party service providers 108, or the like), one or more data networks 106 or other communication channels, one or more third-party service providers 108 (e.g., one or more servers 108 of one or more service providers 108; one or more cloud or network service providers 108, or the like), one or more backend servers 110 and/or one or more core processing systems 122a-n. In certain embodiments, even though a specific number of hardware computing devices 102, verification modules 104, data networks 106, third-party service providers 108, backend servers 110, and/or core processing systems 122a-n are depicted in FIG. 1A and FIG. 1B, one of skill in the art will recognize, in light of this disclosure, that any number of hardware computing devices 102, verification modules 104, data networks 106, third-party service providers 108, backend servers 110, and/or core processing systems 122a-n may be included in the systems 100, 120.

In general, a verification module 104 is configured to monitor and/or analyze (e.g., in response to a request to perform an action, in real-time, continuously, or the like) one or more transactions (e.g., financial transactions, electronic transactions, network transactions, or the like) and/or identity data to estimate, determine, and/or detect fraud, a likelihood of fraud, or the like. For example, in some embodiments, a verification module 104 may determine a likelihood that a user, a user account, and/or another entity is legitimate (e.g., rather than fraudulent) in addition to or in conjunction with an account verification process, an asset verification process, or the like.

A verification module 104, in certain embodiments, may process and/or analyze transactional and/or identity data to determine if there are behaviors and/or patterns indicating fraud. In response to detecting one or more behaviors and/or patterns indicating fraud, a verification module 104 may provide one or more alerts or other notifications to an administrator user, a third-party 108 (e.g., a financial institution, a service provider, a customer, a client, and/or another entity), or the like, may determine a confidence score indicating a likelihood that a user, account, or other entity is fraudulent, is not fraudulent, or the like based on the transaction and/or identity data.

For example, in some embodiments, a verification module 104 may analyze an age of an account (e.g., opened the same day, within a few days, a week ago, a month ago, a year ago, several years ago, or the like), with newer accounts being more likely to be fraudulent. In further embodiments, a verification module 104 may analyze a frequency of transactions, a number of transactions, a monetary amount of one or more transactions, a total monetary amount of transactions, an average monetary amount of transactions, a date of a most recent transaction, a repetitive nature of transactions (e.g., repeated similar transaction amounts, transaction parties, or the like), an oldest deposit, a most recent deposit, a monetary amount of a deposit, or the like for inbound transactions, outbound transactions, and/or both. A verification module 104 may analyze a type of account, how an account is being used (e.g., a personal account being used as a business account, vice versa, or the like), a role a specific user plays for an account with multiple users, and/or other attributes of an account or its usage.

In one embodiment, a third-party 108 (e.g., a financial institution, a service provider, a customer, a client, and/or another entity) may provide a verification module 104 with transaction data, account data, identity data, or other data held by the third-party 108 for the user, account, or other entity being verified. A verification module 104, in some embodiments, may match a user, account, or other entity being verified to other records for the user, account, or other entity (e.g., to match or verify an identity, a likelihood of fraud, or the like) and may notify a third-party 108 or other entity requesting the verification of the match (e.g., a financial institution, a service provider, a customer, a client, and/or another entity).

In this manner, in various embodiments, a verification module 104 may provide robust verification of an identity of an individual user, an account, or other entity, with a confidence score or other metric indicating a strength of the identity match, a likelihood of fraud, or the like.

A verification module 104, in some embodiments, may be configured to manage and/or verify user accounts and/or actions (e.g., via executable applications 114, an API, or the like) dynamically based on a confidence score indicating a likelihood that the user and/or an account is fraudulent (e.g., based on user data, financial account and/or transaction data, or the like). For example, a verification module 104 may determine a confidence score and/or another fraud assessment for a user and/or account based on transaction data, account data, security or other risk submissions by the user, monitoring a set of steps taken by the user (e.g., registration steps, training steps, sandbox steps, or the like), live monitoring of third-party sources (e.g., the dark web, online articles, government filings, lawsuits, or the like), and/or other security and/or risk factors.

In certain embodiments, a verification module 104 may determine a scope of actions allowed for a user and/or account based on the current dynamic confidence score and/or other fraud assessment for the user and/or account (e.g., dynamically expanding or restricting available actions based on changes in the confidence score). For example, in response to a confidence score indicating an increase in determined fraud risk for an account and/or user, a verification module 104 may limit a number of transactions allowed for a user and/or account during a period of time, may limit a monetary amount of transactions allowed for a user and/or account during a period of time (e.g., a maximum monetary amount for a transaction, a cumulative monetary amount for transactions, an average monetary amount for transactions, or the like), may limit a type of transactions allowed for a user and/or account, may close and/or deny an account, may put a hold on an account, may alert a third-party service provider 108 or other client, or the like.

A verification module 104, in some embodiments, may dynamically notify a third-party (e.g., a third-party service provider 108 or other client, the user, an administrator, and/or another entity) of updates to a confidence score (e.g., increased fraud risk, decreased fraud risk, or the like). In certain embodiments, a verification module 104 may provide an API, portal, dashboard, GUI, and/or other user interface to a third-party service provider 108a-n and/or another client, displaying dynamic confidence scores, or the like (e.g., allowing the third-party service provider 108a-n to set risk thresholds, manually adjust allowed and/or blocked actions, view changes in confidence scores and/or scopes of actions, or the like).

A verification module 104, in one embodiment, is configured to verify an existence of and/or a status of one or more accounts of a user (e.g., financial accounts, online service provider accounts, social media accounts, or the like) with minimal or no user interaction, input, feedback, or the like. As used herein, account verification (or instant account verification) enables entities such as businesses, banks or other financial institutions, or the like to verify whether a user and/or account is valid or fraudulent in real-time, within seconds, or the like.

For instance, a user of a financial institution (e.g., a bank, a credit union, a lender, a mortgage company, a financial technology company, or the like) may provide their electronic credentials (e.g., a username and password or other credentials), for the account to be verified. A verification module 104 may log in on behalf of that user and securely return account information (e.g., the account and/or routing number, transaction data, or the like) to the financial institution as verified.

In certain embodiments, a verification module 104 on a user's hardware device 102 (e.g., as part of an application 114, or the like) may communicate with a verification module 104 for a third-party entity 108 (e.g., either directly and/or through one or more backend verification modules 104 on one or more backend servers 110, or the like) over a data network 106, or the like. In this manner, in some embodiments, a verification module 104 may verify a user, verify an account, complete a transaction, or the like between a user and a third-party entity 108 using a hardware device 102 of the user instead of a payment card and/or a payment card network, authenticating a user rather than a card.

In one embodiment, as described in greater detail below, a verification module 104 may be part of, integrated with, and/or in communication with a personal financial management (PFM) mobile application 114 executing on a mobile hardware device 102 for the user, and may already have access to and/or authorization from the user to access one or more of the user's financial accounts (e.g., accounts with a plurality of third-party financial institutions 108, 114 or the like) using the user's electronic credentials. A verification module 104 may use the user's electronic credentials to aggregate transaction data for the user, to verify an availability of funds and/or credit, to send payment for a transaction, or the like. A verification module 104, in some embodiments, may cleanse, categorize, classify, and/or otherwise process the user's aggregated financial transaction data from one or more third-party financial accounts (e.g., to facilitate accurate fraud detection for subsequent financial transactions, or the like).

In one embodiment, a verification module 104 for a third-party entity 108, in response to a completed transaction or the like, may provide item level data for the transaction to a verification module 104 for the user, to a backend verification module 104, or the like. In other embodiments, a verification module 104 may provide item level data prior to completion of a transaction, and a verification module 104 may use the item level data for fraud detection for the transaction. Item level data is described in greater detail below. For example, in some embodiments, a verification module 104 may provide the item level data as an electronic receipt to the user on a hardware device 102 for the user, or the like.

In one embodiment, a verification module 104 is configured to determine and/or receive a user's electronic credentials (e.g., username and password, fingerprint scan, retinal scan, digital certificate, personal identification number (PIN), challenge response, access token, hardware token, software token, DNA sequence, signature, facial recognition, voice pattern recognition, bio-electric signals, two-factor authentication credentials, or the like) for one or more third-party entities 108. The verification module 104, in certain embodiments, accesses a server 108 of a third-party entity 108 using a user's electronic credentials to download data associated with the user from the server 108, such as a user's photos, a user's social media posts, a user's medical records, a user's financial transaction records or other financial data, and/or other data associated with and/or owned by a user but stored by a server 108 of a third-party entity 108 (e.g., stored by hardware not owned, maintained, and/or controlled by the user).

A verification module 104, in various embodiments, may provide the downloaded data to the user locally (e.g., from an application 114, displaying the data on an electronic display of a hardware device 102, or the like); may provide the downloaded data from the hardware device 102 of the user to and/or package the data for a remote server 110 (e.g., a backend verification module 104) or other remote device (e.g., another hardware device 102 of the user, a hardware device 102 of a different user, or the like) which may be unaffiliated with the third-party entity 108; may provide one or more alerts, messages, advertisements, or other communications to the user (e.g., on a hardware device 102) based on the downloaded data; or the like.

In one embodiment, a verification module 104 is configured to use the user's received electronic credentials to verify an account for the user, an account balance, one or more account transactions, or the like. As described above, a verification module 104 may verify an account in real time (e.g., substantially instantly), using electronic credentials of the user for the account (e.g., an account number and PIN/password, a username and password, an access token, or the like). In such an embodiment, a verification module 104 may receives electronic credentials from a user, from a password manager, from a third-party service provider 108 (e.g., receiving an access token in response to the user authenticating with the third-party service provider 108), or the like. The electronic credentials may, in certain embodiments, include one or more access tokens that may be issued to a verification module 104 or other entity by an authorization server, with the approval of the resource owner. The verification module 104 may then use the access token to access the protected resources hosted by the resource server.

For example, a verification module 104 may attempt to login to the user's account by presenting the user's access tokens as part of an OAuth service, or the like. As used herein, OAuth may refer to an open standard/service for access delegation, commonly used as a way for Internet users to grant websites or applications access to their information on other websites but without giving them the passwords. In another example, a verification module 104 may attempt to login to a user's account using a webpage associated with the account (e.g., an HTTP interface, a screen scrape, or the like), may use an API associated with the account, or the like.

In various embodiments, a verification module 104, in response to successfully logging into the user's account using the user's electronic credentials, may be configured to verify an existence of an account, a status of an account, contents of an account (e.g., an amount present in a financial account, verification of assets, verification of income, or the like), a capability or limitations of an account (e.g., other services that the user has access to, or does not have access to), a subscription and/or membership level associated with an account, a number of posts associated with an account (e.g. social media posts, image posts, product reviews, or the like), a most recent post associated with an account, a number of friends and/or followers associated with an account, or the like.

In some embodiments, a verification module 104 is configured to use multiple methods to verify an account (e.g., in a failover, rollover, fallback, round robin, and/or other configuration). For example, in one embodiment, a verification module 104 may attempt to login to a user's account to verify the account using the user's electronic credentials (e.g., using a web/HTTP interface, an OAuth service, and/or an API interface), and in response to the attempted verification failing, the verification module 104 may attempt to verify the account using a different method, such as microdeposits, and/or may use another verification method.

As used herein, microdeposits are deposits into a user's account, usually two or more deposits of small amounts, that, when the user sees the deposits in their account, enters the amounts of the deposits into an interface of the entity that made the deposits to verify the user's account. The order and/or verification methods used by a verification module 104, in some embodiments, may be configurable and/or customizable, based on one or more preferences of a user, an entity verifying the user's account, or the like (e.g., a verification module 104 may use different failover methods, different verification methods, or the like for different users, different customers/clients, or the like).

A verification module 104 (e.g., located at a personal financial management application/system/platform, at a third party such as a bank or other financial institution, or the like), in one embodiment, may automatically verify one or more microdeposits into an account based on financial transaction data aggregated for the user from the account. For example, in some embodiments, a user may have already previously connected to and/or setup an account for aggregation using a verification module 104, and in response to a third-party requesting verification of the account, the verification module 104 may send one or more microdeposits to the account, and may process subsequent transaction data aggregated for the account to verify proper receipt of the one or more microdeposits (e.g., matching amounts, a party to the transaction, or the like in a self-confirming manner).

For instance, a verification module 104, as part of a personal financial management platform/application or a third-party system, may deposit $0.50 and $0.37 cents into the user's account that the third-party wants to verify in response to a request from the third party to verify the account. A verification module 104 may then access the user's aggregated transaction data (e.g., without accessing the user's account directly, e.g., using a bank's website), and process the transaction data looking for the two microdeposits into the account. A verification module 104 may then determine whether the microdeposits are present in the aggregated transaction data, and if so, may determine whether the amounts of the microdeposits match the amounts that were deposited into the user's account and further send a confirmation or verification to the third party that the microdeposits are present in the user account. In this manner, in one embodiment, a verification module 104 may verify an account for a user with little or no additional participation and/or input by the user (e.g., without the user manually entering an amount of a microdeposit to confirm the amount, or the like).

In further embodiments, the verification module 104 submits the microdeposit transaction information (e.g., an amount of the microtransaction, a party of the transaction, and/or other identifying information) from the user's transaction data at a third party that requests verification of the user's account. For instance, the verification module 104 may submit the microdeposit transaction information using an API of the third party, using an interface of the third party (e.g., a website that the verification module 104 scraps to locate a graphical input location of the website for the microtransaction information), or the like.

In other embodiments, a verification module 104 may verify an account based on financial transaction data that is aggregated from a plurality of transaction data sources (e.g., bank servers 108) for the account (e.g., based on previous financial transactions already aggregated for the account, without additional microdeposits or other verification, or the like). In such an embodiment, the financial transaction data may be aggregated at a data aggregation server, which may be a first party server and/or a third-party server. For instance, the verification module 104 may receive the user's electronic credentials at the data aggregation server and the data aggregation server may attempt to login into the user's account on behalf of the user using the received electronic credentials. Upon successfully logging into the user's account, the user's account information, e.g., financial transaction data such as the account number, routing number, or the like may be received at the data aggregation server.

In one embodiment, a verification module 104 is configured to collect at least a portion of the electronic credentials or other user information (e.g., a name, an identifier, an account number, a routing number, or the like) using an (automated) scan (e.g., a photo, optical character recognition, image recognition, or the like) or screenshot of a document such as a voided check, a deposit slip, a receipt, a financial statement, a credit card statement, a mortgage statement, government identification, or the like. In further embodiments, the verification module 104 verifies the account information using the information that the verification module 104 captures, e.g., by comparing account information such as account numbers, user information (e.g., name, address, social security numbers, or the like), routing numbers, or the like.

In one embodiment, a verification module 104 collects a minimal amount of information from a user based on a verification order and/or method selected for verification of the user's account (e.g., so that the verification module 104 does not collect additional information from the user in response to one or more verification attempts failing). For example, a verification module 104 may prompt the user for the user's electronic credentials, for a name, for an account number, or the like. Thus, a verification module 104 may request information from the user for verifying the user's account at one time without subsequently requesting additional information from the user in response to the account verification failing.

In another embodiment, a verification module 104 may collect information from a user for a first verification method initially, e.g., using electronic credentials, and may subsequently collect additional information from the user for a second verification method, e.g., microdeposits, in response to the first verification method failing, or the like. For example, a verification module 104 may request the user's electronic credentials for account verification, and, in response to the account verification failing, subsequently request account information from the user for verifying the user's account using the one or more microdeposits.

In one embodiment, a verification module 104 is configured to provide one or more reports and/or other messages to a user associated with an account being verified, to a third-party entity requesting verification of the account, or the like (e.g., using a graphical user interface of a hardware device 102, an email, a text message, a push notification, or the like). A verification module 104 may notify a user and/or a third-party of success or failure of an account verification, of a failover order of verification methods used (e.g., an audit trail, proof of diligence, a log, or the like), or the like.

In one embodiment, the verification module 104 generates reports that indicate whether the user's account was verified successfully, whether the user's electronic credentials were successfully used to verify the user's account, whether microdeposits were used to verify the user's account in response to failing to verify the user's account using the user's electronic credentials and the amounts of the microdeposits, or the like.

In general, a datapath module 112 provides electronic access and/or another connection to data, such as data from one or more core processing systems 122a-n, or the like, to a verification module 104, to one or more executable applications 114, to a backend server 110, over a data network 106, or the like. A core processing system 122, as used herein, comprises one or more hardware computing devices and/or computer executable program code for storing, tracking, processing, and/or updating transaction data, account data, other data, or the like for one or more users. For example, in embodiments where a third-party service provider 108 comprises a bank or other financial institution, a core processing system may comprise a backend system that processes financial transactions, posts updates to financial accounts (e.g., deposit accounts such as savings and/or checking accounts, loan or other credit accounts, investment accounts, mortgage accounts, credit card accounts, or the like), and/or provides other general ledger or financial reporting functions. Core processing systems 122a-n may have different compatibilities, functions, requirements, or the like and may be installed on premises, may be cloud-based and installed on a backend server 110, may be accessible over a data network 106, or the like. A datapath module 112 may connect one or more core processing systems 122a-n to a verification module 104 and/or to one or more other interfaces or services.

In one embodiment, a datapath module 112 may be configured to simultaneously support multiple account/transaction core processing systems 122a-n, providing a user (e.g., a financial institution, a third-party entity, or the like) with real-time access to each account/transaction core processing system 122 through the same endpoint (e.g., a verification module 104 or other application programming interface) or other interface, even if different identifiers, different tokens or other electronic credentials, or the like may be used for the same user for the different cores 122a-n on the backend for the datapath module 112 to access the different cores 122a-n. In one embodiment, the datapath module 112 maintains simultaneous access to the different core processing systems 122a-n overtime, on an ongoing basis. In a further embodiment, the datapath module 112 automatically migrates users from a first account/transaction core processing system 122 to a second (e.g., different) account/transaction core processing system 122 over time.

For example, a datapath module 112 may support multiple different account/transaction core processing systems 122a-n on the same backend for the same set of users, providing access to the multiple different account/transaction core processing systems 122a-n through the same endpoint (e.g., the same verification module 104, the same API, the same online portal, the same mobile and/or desktop application 114, another user interface, or the like). For example, in some embodiments, a datapath module 112 may enable a financial institution or other entity 108 to use different core processing systems 122a-n for checking/savings accounts than for credit cards, than for mortgages, or the like on an ongoing basis, without immediately or necessarily migrating between the cores 122a-n, or to seamlessly continue to support multiple account/transaction core processing systems 122a-n after a merger, or the like.

Because user and/or account identifiers may be different for the different account/transaction core processing systems 122a-n, a datapath module 112, in some embodiments, may maintain an identity repository or other data structure mapping user and/or account identifiers between account/transaction core processing systems 122a-n. Similarly, a datapath module 112 may maintain separate electronic credentials (e.g., authorization tokens, usernames and passwords, or the like) for each user and/or account for the different account/transaction core processing systems 122a-n, but may provide a single point of validation and/or authentication for the user to access the multiple account/transaction core processing systems 122a-n (e.g., using the separate authorization tokens or other electronic credentials once the user has been authenticated, or the like). For example, during registration, an initial login, or the like for a user, a datapath module 112 may query multiple account/transaction core processing systems 122a-n to determine if the user has an account, and may populate the identity repository with the resulting identifiers for the user, for the accounts, or for other account information.

In some embodiments, a datapath module 112 automatically migrates user accounts between different core account processing systems 122a-n. A datapath module 112, in certain embodiments, may migrate accounts in a user-led manner, delaying migration of a user's account until the user logs in to a new environment, or otherwise provides user input to a user input element, or the like. A datapath module 112, in response to determining to migrate an account between core account processing systems 122a-n, may close an account on a first core processing system 122, create a new account on a second core processing system 122, and transfer funds from the closed account to the new account, or the like. In this manner, by waiting for a user to login or otherwise interact with a displayed user interface element before migrating, migration may be throttled or spread out over time, and the user may be allowed to opt-in to the migration, allowing early adopters or more frequent users to be migrated first. A datapath module 112, in this manner, may also help the migrating financial institution 108a-n to satisfy certain contractual obligations, by migrating the most active users first, or the like. A datapath module 112, in certain embodiments, provides a seamless migration between core account processing systems 122a-n over time, as users self-select for migration.

In one embodiment, a system 100, 120 includes one or more hardware computing devices 102. The hardware computing devices 102 (e.g., hardware computing devices, information handling devices, or the like) may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware computing devices 102 are in communication with one or more servers 108 of one or more third-party service providers 108 and/or one or more backend servers 110 via a data network 106, described below. The hardware computing devices 102, in a further embodiment, are capable of executing various programs 114, program code 114, applications 114, instructions 114, functions 114, or the like.

In one embodiment, a verification module 104 is configured to determine and/or receive a user's electronic credentials (e.g., username and password, fingerprint scan, retinal scan, digital certificate, personal identification number (PIN), challenge response, access token, hardware token, software token, DNA sequence, signature, facial recognition, voice pattern recognition, bio-electric signals, two-factor authentication credentials, or the like) for one or more third-party service providers 108, for one or more core processing systems 122a-n, for an application 114, for a verification module 104, or the like. The verification module 104, in certain embodiments, accesses a server 108 of a third-party service provider 108, a core processing system 122a-n, or the like using a user's electronic credentials to download data associated with the user, such as a user's photos, a user's social media posts, a user's medical records, a user's financial transaction records or other financial data, and/or other data associated with and/or owned by a user but stored by a server 108 and/or core processing system 122a-n of a third-party service provider 108 (e.g., stored by hardware not owned, maintained, and/or controlled by the user). The verification module 104, in various embodiments, may provide the downloaded data to the user locally (e.g., displaying the data from an application 114 to an electronic display screen of a hardware computing device 102); may provide the downloaded data from the hardware computing device 102 of the user to and/or package the data for an intermediary 110 or other remote server 110 (e.g., a backend verification module 104) or other remote device (e.g., another hardware computing device 102 of the user, a hardware computing device 102 of a different user, or the like) which may be unaffiliated with the third-party service provider 108; may provide one or more alerts, messages, advertisements, or other communications to the user (e.g., from an application 114 on a hardware computing device 102) based on the downloaded data; or the like.

In certain embodiments, the system 100, 120 includes a plurality of verification modules 104 disposed, located, and/or in communication with different third-party service providers 108a-n, each in communication with one or more intermediaries 110 or other hardware server computing devices 110 which may communicate data from the verification modules 104 to users via the applications 114 and/or other data recipients 114. The plurality of verification modules 104 may execute across multiple hardware computing devices, may be geographically dispersed and using different IP addresses, and/or may download and/or aggregating data (e.g., photos, social media posts, medical records, financial transaction records, other financial data, and/or other user data) separately for different third-party service providers 108 (e.g., a financial institution, bank, credit union, and/or other online banking provider; a social media site; a medical provider; a photo hosting site; or the like).

In one embodiment, at least a portion of a verification module 104 may be integrated with or otherwise part of another application executing on a hardware computing device 102, such as a personal financial management application (e.g., computer executable code for displaying a user's financial transactions from multiple financial institutions, determining and/or displaying a user's financial budgets and/or financial goals, determining and/or displaying a user's account balances, determining and/or displaying a user's net worth, or the like), a photo viewer, a medical application, an insurance application, an accounting application, a social media application, or the like, which may use data the verification module 104 downloads from a server 108 of a third-party service provider 108.

The one or more verification modules 104, in certain embodiments, may provide an interface (e.g., an application programming interface (API), a graphical user interface of an application 114, or the like) to provide downloaded and/or aggregated user data from servers 108, core processing systems 122a-n, or the like of one or more third-party service providers 108 to one or more other entities (e.g., an application 114 or other data recipient entity, a remote server 110 or other hardware computing device 102 unaffiliated with the third-party service provider 108, or the like). The interface, in one embodiment, comprises a private interface between applications 114 executing on users' hardware computing devices 102 and one or more verification modules 104. In another embodiment, the interface comprises a public and/or open interface, which may be secured, allowing a user to share the user's downloaded data from a verification module 104 to one or more other tools, services, and/or other entities to store, process, and/or otherwise use the data.

In various embodiments, a verification module 104 and/or a datapath module 112 may be embodied as hardware, software, or some combination of hardware and software. In one embodiment, a verification module 104 and/or a datapath module 112 may comprise executable program code stored on a non-transitory computer readable storage medium for execution on a processor of a hardware server computing device 108, 110, or the like. For example, a verification module 104 and/or a datapath module 112 may be embodied as executable program code executing on one or more of a hardware computing device 102, a hardware server computing device 108, 110, a combination of one or more of the foregoing, or the like. In such an embodiment, the various modules that perform the operations of a verification module 104 and/or a datapath module 112, as described below, may be located on a hardware computing device 102, a hardware server computing device 108, 110, a combination thereof, or the like.

In various embodiments, a verification module 104 and/or a datapath module 112 may be embodied as a hardware appliance that can be installed or deployed on a backend server 108, 110, on a user's hardware computing device 102 (e.g., a dongle, a protective case for a phone 102 or tablet 102 that includes one or more semiconductor integrated circuit devices within the case in communication with the phone 102 or tablet 102 wirelessly and/or over a data port such as USB or a proprietary communications port, or another peripheral device), or elsewhere on the data network 106 and/or collocated with a server 108, 110 and/or a user's hardware computing device 102. In certain embodiments, a verification module 104 and/or a datapath module 112 may comprise a hardware computing device such as a secure hardware dongle or other hardware appliance device (e.g., a set-top box, a network appliance, or the like) that attaches to another hardware computing device 102, 108, 110, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of a verification module 104 and/or of a datapath module 112 may comprise a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to a verification module 104 and/or a datapath module 112.

A verification module 104 and/or a datapath module 112, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, a verification module 104 and/or a datapath module 112 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of a verification module 104 and/or a datapath module 112.

The semiconductor integrated circuit device or other hardware appliance of a verification module 104 and/or a datapath module 112, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of a verification module 104 and/or a datapath module 112 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The one or more third-party service providers 108, in one embodiment, may include one or more network accessible computing systems such as one or more core processing systems 122a-n, one or more web servers hosting one or more web sites, an enterprise intranet system, an application server, an application programming interface (API) server, an authentication server, or the like. The one or more third-party service providers 108 may include systems related to various institutions or organizations. For example, a third-party service provider 108 may include a system providing electronic access to a financial institution, a university, a government agency, a utility company, an email provider, a social media site, a photo sharing site, a video sharing site, a data storage site, a medical provider, or another entity that stores data associated with a user. A third-party service provider 108 may allow users to create user accounts to upload, view, create, and/or modify data associated with the user. Accordingly, a third-party service provider 108 may include an authorization system, such as a login element or page of a web site, application, or similar front-end, where a user can provide credentials, such as a username/password combination, to access the user's data.

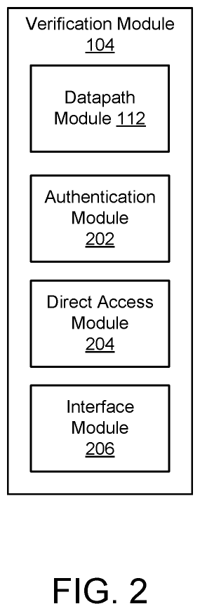

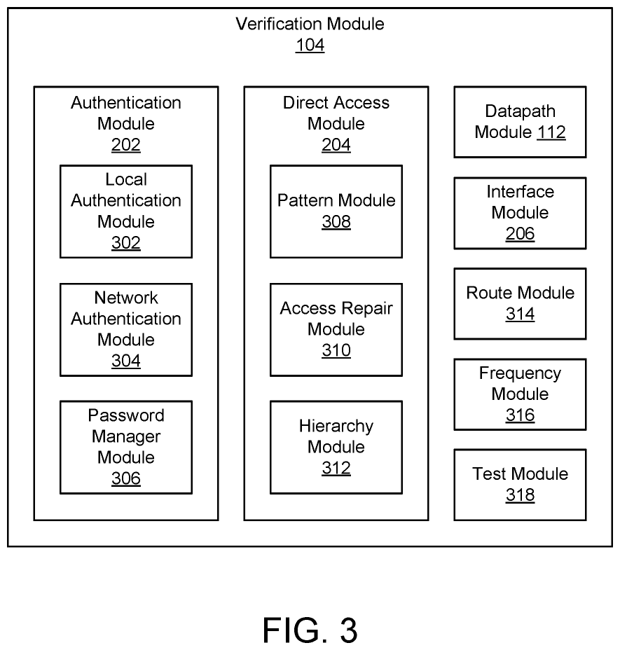

In one embodiment, the one or more backend servers 110 and/or one or more backend verification modules 104 provide central management of networked verification modules 104 and/or datapath modules 112. For example, the one or more backend verification modules 104 and/or a backend server 110 may store downloaded user data from the verification modules 104 and/or datapath modules 112 centrally, may provide instructions for the verification modules 104 and/or datapath modules 112 to access user data from one or more third-party service providers 108 using tokens or other electronic user credentials, or the like. A backend server 110 may include one or more servers located remotely from the hardware computing devices 102 and/or the one or more third-party service providers 108. A backend server 110 may include at least a portion of the modules or sub-modules described below with regard to the verification modules 104 of FIG. 2 and FIG. 3, may comprise hardware of a verification module 104 and/or a datapath module 112, may store executable program code of a verification module 104 and/or a datapath module 112 in one or more non-transitory computer readable storage media, and/or may otherwise perform one or more of the various operations of a verification module 104 and/or a datapath module 112 described herein.

FIG. 2 depicts one embodiment of a verification module 104. In the depicted embodiment, the verification module 104 includes a datapath module 112, an authentication module 202, a direct access module 204, and an interface module 206. The datapath module 112, in certain embodiments, may be substantially similar to the datapath module 112 described above with regard to FIG. 1A and FIG. 1B.

In one embodiment, the authentication module 202 receives a user's electronic credentials for a third-party service provider 108, for a core processing system 122a-n, or the like from the user on a hardware computing device 102 of the user. In embodiments where a verification module 104 comprises hardware (e.g., a semiconductor integrated circuit device such as an FPGA, an ASIC, or the like), the authentication module 202 may comprise dedicated security hardware for storing and/or processing electronic credentials, downloaded data, and/or other sensitive and/or private data, such as a secure cryptoprocessor (e.g., a dedicated computer on a chip or microprocessor embedded in a packaging with one or more physical security measures) which does not output decrypted data to an unsecure bus or storage, which stores cryptographic keys, a secure storage device; a trusted platform module (TPM) such as a TPM chip and/or TPM security device; a secure boot ROM or other type of ROM; an authentication chip; or the like. In another embodiment, the authentication module 202 may store and/or process electronic credentials, downloaded data, and/or other sensitive data in a secure and/or encrypted way using software and/or hardware of a user's existing hardware computing device 102 (e.g., encrypting data in RAM, NAND, and/or other general purpose storage) with or without dedicated security hardware.

In one embodiment, as described above, electronic credentials may comprise one or more of a username and password, fingerprint scan, retinal scan, digital certificate, personal identification number (PIN), challenge response, access token, hardware token, software token, DNA sequence, signature, facial recognition, voice pattern recognition, bio-electric signals, two-factor authentication credentials, or other information whereby the authentication module 202 may authenticate and/or validate an identity of and/or an authorization of a user.

The authentication module 202, in certain embodiments, may receive different credentials from a user for different accounts of the user with different third-party service providers 108 (e.g., different social networks, different photo sharing sites, different financial institutions) so that the verification module 104 may download, aggregate, and/or combine the user's data from the multiple different third-party service providers 108. In one embodiment, as described below with regard to the password manager module 306 of FIG. 3, the authentication module 202, instead of and/or in addition to receiving one or more passwords or other electronic credentials from a user, may manage and/or determine one or more passwords or other electronic credentials for a user for one or more third-party service providers 108. For example, in certain embodiments, the authentication module 202 may receive an initial set of electronic credentials (e.g., a username and a password) from a user for an account of the user with a third-party service provider 108, and the authentication module 202 may use the initial set of electronic credentials to access the user's account with the third-party service provider 108 to set a new password, determined by the authentication module 202. The authentication module 202, in one embodiment, may determine passwords or other electronic credentials that are more secure than those typically created by and/or memorable to a user (e.g., longer, more numbers, greater variation between capital and lowercase letters, more frequently changed, or the like).

In one embodiment, the direct access module 204 accesses one or more servers 108 of one or more third-party service providers 108, core processing systems 122a-n, datapath modules 112, or the like using a user's electronic credentials from the authentication module 202. The direct access module 204, in certain embodiments, downloads data associated with a user (e.g., a user's social media posts, a user's photos, a user's financial transactions or financial account information, or the like) from one or more servers 108 of one or more third-party service providers 108, from one or more core processing systems 122a-n, or the like to a hardware computing device 102 of a user and/or to a backend server 110 or other intermediary 110 associated with the direct access module 204, or the like.

In some embodiments, such as if an API or other interface is not available, the direct access module 204 may use a webpage interface of a server 108 of a third-party service provider 108 to access the server 108 using a user's electronic credentials and/or to download data associated with the user. For example, in certain embodiments, the direct access module 204 may download/load a webpage from a server 108 of a third-party service provider 108, enter a username and password or other electronic credentials for a user into textboxes in a form on the webpage, submit the username and password or other electronic credentials using a submit button or other interface element of the webpage, and/or otherwise submit electronic credentials using a website to gain authorized access to data on the server 108 associated with the user. As described below, the pattern module 308 may receive and/or provide instructions enabling the direct access module 204 to access a server 108 (e.g., a location or method for submitting electronic credentials, or the like).

In response to successfully authenticating with and accessing a server 108 of a third-party service provider 108, a core processing system 122a-n, or the like with a user's electronic credentials, the direct access module 204 may download data associated with the user (e.g., from a user's account or the like) to a hardware computing device 102 associated with the user, to a backend server 110, or the like. As described below, in certain embodiments, the pattern module 308 may receive and/or provide instructions enabling the direct access module 204 to download data associated with a user from a server 108 of a third-party service provider 108 (e.g., a URL or other link to a location for the data, a label or other identifier for locating the data within one or more webpages or other data structures, or the like). The direct access module 204, in certain embodiments, may follow instructions from a pattern module 308 to authenticate and/or access data from one or more webpages from a server 108 in a screen scraping manner, parsing one or more webpages to locate an entry location and/or submit electronic credentials; to locate, download, and/or extract data associated with a user; or the like.

In one embodiment, the direct access module 204 sends or otherwise submits electronic credentials and/or receives or otherwise downloads data using an API or other access protocol of a server 108 and/or core processing system 122a-n of a third-party service provider 108. For example, the direct access module 204 may send a request in a format specified by and/or compatible with a server 108 (e.g., an API server 108) and/or a core processing system 122a-n of a third-party service provider 108. The sent request may comprise electronic credentials for a user or a portion thereof (e.g., a username and/or a password), a subsequent request may comprise electronic credentials for a user or a portion thereof (e.g., in response to receiving an acknowledgment from the server 108 and/or core processing system 122 for the first request, or the like), and/or the direct access module 204 may use a different access protocol.

In response to a request for data from the direct access module 204 (e.g., in response to the direct access module 204 authenticating a user using an access protocol of a server 108 and/or a core processing system 122), a server 108 and/or a core processing system 122 of a third-party service provider 108 may send and/or return data associated with a user (e.g., in one or more messages, packets, payloads, as a URL or other pointer to a location from where the direct access module 204 may retrieve the data, to the datapath module 112, or the like). The direct access module 204, in various embodiments, may receive data associated with a user directly from a server 108 and/or a core processing system 122 of a third-party service provider 108 over a data network 106; may receive a pointer, URL or other link to a location of data associated with a user from a server 108 and/or core processing system 122 of a third-party service provider 108; may receive data associated with a user from another entity on a data network 106 (e.g., in response to a request from the server 108 and/or core processing system 122 of the third-party service provider 108 to the other entity or the like); or may otherwise receive data associated with a user according to an access protocol of a third-party service provider 108.

In one embodiment, a third-party service provider 108 provides a direct access module 204 with an API or other access protocol. In a further embodiment, a direct access module 204 may act as a wrapper for and/or a plugin or extension of, an application of a third-party service provider 108 (e.g., a mobile application), and the application may have access to an API or other access protocol of the third-party service provider 108. In another embodiment, a direct access module 204 may be configured to use an API or other access protocol in a same manner as an application of a third-party service provider 108 (e.g., a mobile application), third-party service, or the like.

The direct access module 204, in certain embodiments, may access different third-party service providers 108 in different manners. For example, a first third-party service provider 108 may grant the direct access module 204 with access to an API or other access protocol, while the direct access module 204 may use a web page interface (e.g., screen scraping) to access and download data from a second third-party service provider 108, or the like. In one embodiment, a remote backend server 110 may be associated with a first party service provider 110 (e.g., a vendor and/or provider of a verification module 104) and the direct access module 204 may download data associated with a user from both the first party service provider 110 and from one or more third-party service providers 108, aggregating the data together so that the user may access the data in a single interface and/or application. For example, as described below with regard to the interface module 206, the interface module 206 may provide a user access to the user's photos from multiple third-party cloud storage providers 108 within a single photo application, may provide a user with access to the user's personal financial information within a single personal financial management application and/or online banking application, may provide a user with access to posts from multiple social networks within a single social networking application, or the like.

The direct access module 204, in certain embodiments, may store downloaded and/or aggregated data independently from the one or more third-party service providers 108. For example, the direct access module 204 may store a user's downloaded and/or aggregated data on a hardware computing device 102 of the user, on a backend server 110 accessible by the user, or the like. In this manner, in certain embodiments, a user may control and/or access the user's data, even if a third-party service provider 108 closes down or is not available, may use the user's data in any manner desired by the user even if the use is not supported by a third-party service provider 108, or the like.

The direct access module 204, in one embodiment, in addition to and/or instead of downloading data from one or more third-party service providers 108, may upload data to and/or change one or more settings of one or more third-party service providers 108, in response to user input or the like. For example, in embodiments where the data comprises photos, the direct access module 204 may upload a photo from a hardware computing device 102 of the user to one or more third-party service providers 110 (e.g., a downloaded photo that the user has edited on the hardware computing device 102 or the like). In embodiments where the data comprises social media posts or other content, the direct access module 204 may receive input from a user (e.g., a photo, a textual post, one or more emoji, a video, a document or other file, or the like) and upload the received input to one or more third-party service providers 108 (e.g., social media sites or the like). In embodiments where the data comprises financial transactions or other financial data, the direct access module 204 may schedule a bill pay or other payment or funds transfer, remotely deposit a check (e.g., by uploading photos of the front and/or back of the check, or the like), and/or perform another action.

The direct access module 204 may update or change a user's account information with a third-party service provider 108, such as an account type or plan, credit card or other payment information associated with an account, a phone number or address or other contact information associated with an account, a password or other electronic credentials for an account, and/or other account information of a user for a third-party service provider 108. The direct access module 204 may update and/or upload data in a substantially similar manner to that described herein for downloading data (e.g., determining a user's electronic credentials for a third-party service provider 108, accessing a server 108 of the third-party service provider 108, uploading and/or providing data to the third-party service provider 108, or the like).

In one embodiment, the interface module 206 provides a user's data downloaded by the direct access module 204 to another entity, such as an application 114, a hardware computing device 102 of a user associated with the downloaded data, a remote server 110 or other remote device 102 unaffiliated with (e.g., not owned by, operated by, controlled by, or the like) the third-party service provider 108 from which the data was downloaded, or the like. For example, the interface module 206 may provide an API or other interface to provide a user's downloaded and/or aggregated data to an application 114 or other data recipient 114, to a hardware computing device 102 of the user, to a backend verification module 104, to a backend server 110, to a different third-party service provider 108, to a different/second hardware computing device 102 of the user, or the like (e.g., with consent and/or authorization from the user, at the user's request, or the like).

In certain embodiments, it may be transparent and/or substantially transparent to a user (e.g., not apparent) which hardware computing device 102, 110 has downloaded data associated with the user. For example, the interface module 206 may provide downloaded data associated with a user from one hardware computing device 102 of the user to another hardware computing device 102 of the user, from a hardware computing device 102 of the user to a backend server 110 (e.g., from which the user may access the data using a web browser, an application, or the like), from a backend server 110 to a hardware computing device 102 of the user, or the like, allowing the user to access the data from a different location than the location to which the data was downloaded.

In certain embodiments, the interface module 206 provides a graphical user interface (GUI) on a hardware computing device 102 of a user (e.g., from an application 114 or the like), and provides downloaded data associated with the user to the user through the GUI (e.g., allowing the user to view the data directly, providing one or more notifications and/or recommendations to the user based on the data, providing one or more tables or charts to the user based on the data, providing a summary of or one or more statistics related to the data, or the like). The interface module 206, in various embodiments, may provide a GUI to the user from the same hardware computing device 102 to which the data was downloaded, on a different hardware computing device 102 than the hardware computing device 102, 110 to which the data was downloaded, or the like.

For example, in one embodiment, where the data associated with a user comprises photos, the interface module 206 may provide a photo management interface, a photo editing interface, or the like wherein the user may view and/or otherwise access the user's downloaded and/or aggregated photos. In a further embodiment, where the data associated with a user comprises the user's financial transaction history (e.g., purchases and/or other financial transactions downloaded from one or more financial institutions 108 such as banks, credit unions, lenders, or the like), the interface module 206 may provide a personal financial management interface, with a list of transactions, one or more budgets, one or more financial goals, a debt management interface, a net worth interface, and/or another personal financial management interface wherein the user may view the user's downloaded and/or aggregated financial transaction history, and/or alerts or recommendations based thereon. In another embodiment, where the data associated with a user comprises social media posts, the interface module 206 may provide a GUI comprising a stream, feed, and/or wall of social media posts for the user to view (e.g., downloaded and/or aggregated social media posts from multiple social networks 108, from different contacts or friends of the user, or the like).

The interface module 206, in certain embodiments, may provide one or more access controls to a user, allowing the user to define which applications 114, devices 102, users, third-party service providers 108, or the like may access which data. For example, the interface module 206 may provide an interface for a user to allow and/or restrict certain applications 114, certain APIs for third-party services, certain plugins or extensions, certain users, certain hardware computing devices 102, and/or one or more other entities to access data downloaded for the user from one or more third-party service providers 108 (e.g., with access controls by third-party service provider 108 or other data source, by data type, by entity requesting access, and/or at another granularity). In this manner, the verification module 104, in certain embodiments, may comprise a local repository of aggregated data, which one or more other applications 114, devices 102, and/or services may access and use, with a user's permission.

FIG. 3 depicts another embodiment of a verification module 104. In the depicted embodiment, the verification module 104 includes a datapath module 112, an authentication module 202, a direct access module 204, and an interface module 206 and further includes a route module 314, a frequency module 316, and a test module 318. The authentication module 202, in the depicted embodiment, includes a local authentication module 302, a network authentication module 304, and a password manager module 306. The direct access module 204, in the depicted embodiment, includes a pattern module 308, an access repair module 310, and a hierarchy module 312.

In one embodiment, the local authentication module 302 secures and/or authenticates the user's access to downloaded data, to stored passwords, and/or other data on a user's hardware computing device 102, transferred to and/or from a user's hardware computing device 102, or the like. For example, the local authentication module 302 may cooperate with one or more security and/or authentication systems of the user's hardware computing device 102, such as a PIN, password, fingerprint authentication, facial recognition, or other electronic credentials used by the user to gain access to the hardware computing device 102. In a further embodiment, the local authentication module 302 may authenticate a user before allowing the interface module 206 to provide the user access to downloaded/aggregated data and/or alerts or other messages. For example, the local authentication module 302 may manage and/or access electronic credentials associated with the verification module 104, for a user, and may authenticate the user in response to the user accessing an application and/or service of the verification module 104.

In certain embodiments, the local authentication module 302 may encrypt and/or otherwise secure, on a user's hardware computing device 102, electronic credentials and/or downloaded data associated with a different user, so that the user may not access data associated with the different user, but the different user may access the data once it is transmitted to a hardware computing device 102 of the different user, to a backend server 110, or the like. Local authentication modules 302 of different hardware computing devices 102, 110 may cooperate to securely transfer data (e.g., one or more electronic credentials, downloaded data, or the like) over the data network 106, from one hardware computing device 102, 110 to another hardware computing device 102, 110. In a further embodiment, the local authentication module 302 may ensure that a user's electronic credentials and/or downloaded data remain on a single hardware computing device 102 (e.g., are not transmitted on a data network 106), in a secure repository or the like, and are not stored on and/or accessible to a backend server 110, a hardware computing device 102 of another user, or the like.

In one embodiment, the network authentication module 304 receives and/or stores a user's electronic credentials for one or more third-party service providers 108 on a hardware computing device 102 of the user, on a backend server 110, or the like. The network authentication module 304, in various embodiments, may receive a user's electronic credentials from the user, from a hardware computing device 102 of the user, from a backend server 110, or the like. The network authentication module 304 may cooperate with the direct access module 204 to provide a user's electronic credentials to a server 108 of a third-party service provider 108 (e.g., the network authentication module 304 may provide electronic credentials to the direct access module 204 to provide to a server 108, the network authentication module 304 may provide electronic credentials directly to a server 108, or the like).

The network authentication module 304, in certain embodiments, may cooperate with the local authentication module 302 to encrypt and/or otherwise secure a user's electronic credentials for one or more third-party service providers 108, on a hardware computing device 102 of a user, on a data network 106, on a hardware computing device 102 of a different user, on a backend server 110, while being provided to a server 108 of a third-party service provider 108, or the like. In a further embodiment, the network authentication module 304 ensures that a user's electronic credentials are only stored on a user's hardware computing device 102 and sent from the user's hardware computing device 102 to a server 108 of a third-party service provider 108, and does not store a user's electronic credentials on a backend server 110, on a different user's hardware computing device 102, or the like. In another embodiment, the network authentication module 304 may securely store (e.g., using secure encryption) a user's electronic credentials for a third-party service provider 108 on a backend server 110, on a different user's hardware computing device 102, or the like, so that a direct access module 204 may access and/or download data associated with the user, even if the hardware computing device 102 of the user is unavailable, blocked, or the like, as described below with regard to the route module 314. In certain embodiments, whether the network authentication module 304 and/or the local authentication module 302 allow electronic credentials to be sent to and/or stored by a different user's hardware computing device 102, a backend server 110, or the like may be based on a setting defined based on user input, so that the user may decide a level of security, or the like.

In one embodiment, the password manager module 306 may manage and/or store electronic credentials of a user for a plurality of third-party service providers 108, so that the direct access module 204 may access and/or download data associated with the user from each of the plurality of third-party service providers 108. The password manager module 306, in certain embodiments, may generate and/or otherwise manage different, secure, credentials for each of a plurality of third-party service providers 108.

The password manager module 306, in one embodiment, may securely store generated credentials for a user on a hardware computing device 102 of the user, so that the user does not have to remember and enter the generated electronic credentials. For example, in addition to allowing a direct access module 204 to access a third-party service provider 108 using generated electronic credentials, the password manager module 306 may automatically populate one or more interface elements of a form on a webpage with electronic credentials (e.g., a username, a password) of the user, in response to the user visiting the web page in a web browser, or the like, without the user manually entering the electronic credentials. The password manager module 306, in certain embodiments, may periodically update (e.g., regenerate different credentials, such as a different password, and update the user's account with the third-party service provider 108 with the regenerated different credentials) electronic credentials for a user, such as every week, every month, every two months, every three months, every four months, every five months, every six months, every year, every two years, in response to a user request, in response to a request from a third-party service provider 108, and/or over another time period or in response to another periodic trigger.

The password manager module 306, in one embodiment, may synchronize a user's electronic credentials (e.g., provided by the user, generated by the password manager module 306, or the like) across different hardware computing devices 102, web browsers, or the like of a user. For example, in response to a password manager module 306 and/or the user updating or otherwise changing electronic credentials, the password manager module 306 may propagate the update/change to one or more other password manager modules 306, on different hardware computing devices 102 of the user, or the like.

In one embodiment, the pattern module 308 determines an ordered list (e.g., a pattern, a script, or the like) of multiple locations on one or more servers 108 of a third-party service provider 108 for the direct access module 204 to access the server (e.g., which may include locations other than where the data of the user is stored and/or accessible), one or more delays for the direct access module 204 to wait between accessing locations on the server 108, and/or other components of an access pattern for accessing data of a server. Locations, in certain embodiments, comprise independently addressable and/or accessible content and/or assets provided by one or more servers of a third-party service provider 108, or the like, such as webpages, portions of a webpage, images or other data files, databases or other data stores, pages or sections of a mobile application, or the like. The pattern module 308, in one embodiment, determines a pattern/ordered list that contains one or more locations and/or delays that are not necessary for the direct access module 204 to access or use in order to download desired data, but instead, the pattern/ordered list may make it difficult or impossible for the third-party service provider 108 to distinguish between the direct access module 204 accessing a server of the third-party service provider 108 and a user accessing the server of the third-party service provider.

The pattern module 308, in one embodiment, may determine and/or select the multiple locations and/or the one or more delays (e.g., a pattern/ordered list) based on an average pattern or a combined pattern identified in or based on behavior of multiple users accessing a third-party service provider 108 using a web browser, a mobile application, or the like. The pattern module 308, in one embodiment, may monitor one or more users (e.g., for a predetermined period of time or the like) as they access a server of a third-party service provider 108, tracking which links, data, webpages, and/or other locations the one or more users access, how long the one or more users access different locations, an order in which the one or more users access locations, or the like. In certain embodiments, the one or more monitored users may be volunteers, who have provided the pattern module 308 with authorization to temporarily or permanently monitor the users' access, in order to provide a more realistic access pattern for the direct access module 204 to use to access a server of a third-party service provider 108.

In a further embodiment, the pattern module 308 determines and/or selects multiple locations and/or one or more delays between accessing different locations based on a pattern identified in behavior of the user associated with the hardware computing device 102 on which the pattern module 308 is disposed, accessing the third-party service using a web browser, a mobile or desktop application, or other interface of the user's hardware computing device 102. For example, the pattern module 308 may comprise network hardware of the user's hardware computing device 102 (e.g., a network access card and/or chip, a processor, an FPGA, an ASIC, or the like in communication with the data network 106 to monitor data and/or interactions with a server of a third-party service provider 108), a web browser plugin or extension, a mobile and/or desktop application executing on a processor of the user's hardware computing device 102, or the like. The pattern module 308 may request and receive authorization from the user to monitor the user's activity with regard to one or more servers of one or more third-party service providers 108 from the user's hardware computing device 102.

The pattern module 308, in certain embodiments, may update a pattern/ordered list over time, based on detected changes in access patterns of one or more users or the like. In one embodiment, the pattern module 308 may coordinate and/or cooperate with the access repair module 310, described below, to update a pattern/ordered list in response to a server 108 of a third-party service provider 108 and/or data associated with a user becoming broken and/or inaccessible.

In one embodiment, the access repair module 310 detects that access to a server 108 of a third-party service 108 and/or data associated with a user is broken and/or becomes inaccessible. The access repair module 310, in certain embodiments, provides an interface to a user allowing the user to graphically identify an input location for the user's electronic credentials, a location of data associated with the user, or the like. For example, the access repair module 310 may provide a GUI, a command line interface (CLI), an API, and/or another interface allowing an end user to identify an input location for electronic credentials, an action for submitting electronic credentials, a location of data, or the like. The access repair module 310, in one embodiment, provides an interface to a user on a hardware computing device 102 of the user.

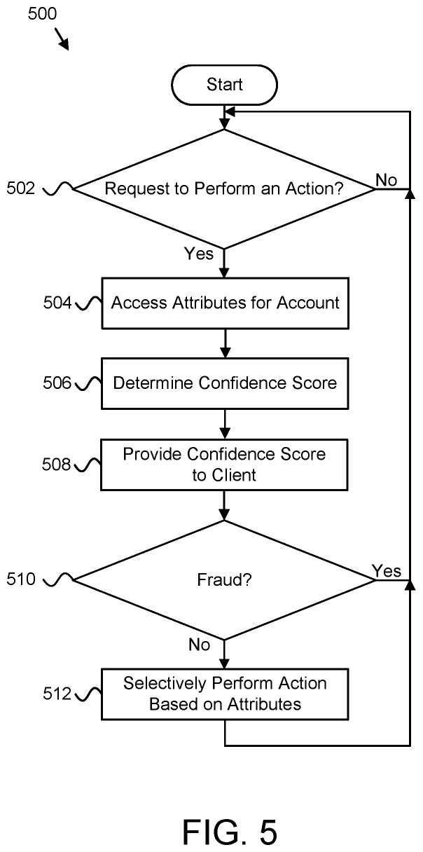

In certain embodiments, for example, the access repair module 310 may overlay an interface over one or more pages of a website of a third-party service provider 108 on an electronic display screen of a user's hardware computing device 102, as described in greater detail below with regard to FIGS. 5A-5B. The access repair module 310 may provide one or more interfaces (e.g., GUIs, CLIs, APIs, overlays, or the like) to multiple users, allowing multiple users to define a repair and/or update for access to a server of a third-party service provider 108 (e.g., in a distributed and/or decentralized manner, from different hardware computing devices 102 or the like over a network 106).

The access repair module 310, in certain embodiments, may determine and/or display one or more suggestions 504 and/or recommendations 504 for the user, which the user may either confirm or change/correct (e.g., in a basic interface, a standard interface, a beginning user interface, or the like). For example, the access repair module 310 may display one or more interface elements with a suggested location for a user to enter a user name, a suggested location for a user to enter a password, a suggested credential submit action, a suggested location of data associated with the user, and/or one or more other interface elements allowing a user to graphically identify one or more locations within a website of a third-party service provider 108.

The access repair module 310, in certain embodiments, processes one or more pages of and/or other locations on a server 108 (e.g., one or more websites, web apps, or the like) to determine an estimate and/or prediction of an input location for a user's electronic credentials, an action for submitting a user's electronic credentials, a location of data associated with a user, or the like. In one embodiment, the access repair module 310 may estimate one or more locations and/or actions (e.g., by scanning and/or parsing one or more pages of a website, based on input from other users accessing one or more pages of a website, based on previous interactions of the user with one or more pages of a website, a prediction made using a machine learning and/or artificial intelligence analysis of a website, based on a statistical analysis of historical changes to one or more pages of a website and/or of one or more similar websites, or the like). The access repair module 310 may display to a user in an interface an estimate and/or prediction of an input location for the user's electronic credentials, a location of data associated with the user, or the like so that the user may confirm whether or not the estimate and/or prediction is correct using the interface.

The access repair module 310 may indicate one or more estimated locations and/or actions with an arrow or other pointer to a location; a link or other identifier of a location; a box or other highlighting around a location; by altering text labeling for a location to make the text bold, italic, and/or underlined; or the like. A user, in certain embodiments, may click, select, or otherwise identify a location to either confirm or change/correct a location suggested by the access repair module 310. For example, a user may click or otherwise select an interface element associated with a location and/or action and may click or otherwise select the location and/or perform the action, which the access repair module 310 may record (e.g., automatically populating a text field identifying the location and/or action, recording a macro allowing the action to be automatically repeated without the user, for a different user, or the like).

In certain embodiments, instead of or in addition to a standard, basic, or beginning user interface, the access repair module 310 may provide an advanced interface, for experienced users or the like, with source code of a website and/or other details of the website. For example, in one embodiment, an advanced access repair interface may allow one or more advanced users to identify one or more locations and/or actions within source code of a website, which may not be visible and/or readily apparent in the website itself. In certain embodiments, the access repair module 310 may provide a user interface element allowing a user to select and/or toggle between a standard user interface or view and an advanced user interface or view.

In one embodiment, the test module 318 cooperates with the access repair module 310 to verify whether or not one or more received locations and/or instructions from a user are accurate (e.g., usable to access data from a server of a third-party service provider 108). The test module 318, in certain embodiments, attempts to access a server 108 of a third-party service provider 108 for a plurality of different users (e.g., a sample group or test set), based on an identification the access repair module 310 received from a single user, using electronic credentials of the different users or the like.

The test module 318, in certain embodiments, determines whether data associated with the different users (e.g., a sample group or test set) is accessible using the identification from the single user. The test module 318 may repeatedly attempt to access data from a third-party service provider 108 using identifications which the access repair module 310 received from different users (e.g., on different hardware computing devices 102 and sent to the test module 318 on a single hardware computing device 102 over the data network 106, sent to multiple test modules 318 on different hardware computing devices 102 over the data network 106, sent to a test module 318 on a central backend server 110, or the like).

The test module 318, in one embodiment, provides one or more identifications from a user to other instances of the direct access module 204 (e.g., other test modules 318) for accessing a server 108 of a third-party service provider 108 in response to an amount of the different users (e.g., a sample group or test set) for which data is accessible using the identification from the single user satisfying a threshold. For example, if the identification from the single user successfully allows a predefined number of other test users (e.g., 2 users, 10 users, 100 users, 1000 users, 50% of test users, 75% of test users, and/or another predefined threshold number of test users) to access their data from a third-party service provider 108, the test module 318 may provide instructions based on the identification to more users (e.g., all or substantially all users, or the like).

In certain embodiments, the test module 318 may successively increase a test size comprising a number of users to which the test module 318 provides instructions for accessing their data from a third-party service provider 108 using an identification from a single user (e.g., starting with one or more test users, increasing to two or more, three or more, four or more, five or more, ten or more, twenty or more, thirty or more, forty or more, fifty or more, one hundred or more, five hundred or more, one thousand or more, five thousand or more, ten thousand or more, one hundred thousand or more, a million or more, and/or other successively increasing numbers of test users). The test module 318, in one embodiment, includes instructions based on an identification from a single user in an ordered list of multiple different sets of instructions for accessing a server 108 of a third-party service provider 108, as described in greater detail below with regard to the hierarchy module 312.

The test module 318, in certain embodiments, is configured to prioritize identifications from one or more users based on one or more trust factors for the one or more users (e.g., scores or the like). A trust factor, in one embodiment, may comprise a score or other metadata indicating a likelihood that a user's identification is correct. For example, in various embodiments, a trust factor may include and/or be based on one or more of a history of a user's previous identifications (e.g., correct or incorrect), a user's affiliation with a provider (e.g., a creator, a vendor, an owner, a seller, a reseller, a manufacturer, the backend server 110, or the like) of the one or more verification modules 104, positive and/or negative indicators (e.g., votes, likes, uses, feedback, stars, endorsements, or the like) from other users, and/or other indicators of whether or not a user's identification is likely to be correct. The test module 318 may determine how many other users to provide a user's identification based on one or more trust factors associated with the user (e.g., accelerating a rate at which a user's identification is provided to other users in response to a higher trust factor, decreasing a rate at which a user's identification is provided to other users in response to a lower trust factor, or the like).

The test module 318 may provide an override interface, allowing an administrator, moderator user, or the like to remove an identification, adjust and/or override an identification, adjust and/or override a trust factor for a user, ban a user from providing identifications, and/or otherwise override a user or a user's identification. In various embodiments, the test module 318 may provide an override interface to an administrator and/or moderator as a GUI, an API, a CLI, or the like.

In certain embodiments, the test module 318 causes the one or more verification modules 104 and their aggregation services to be self healing, self testing, and/or self incrementally deploying, as it tests and uses the most effective solutions, or the like (e.g., sets of instructions based on indications from one or more users).

In one embodiment, the hierarchy module 312 provides the direct access module 204 with an ordered list of multiple different sets of instructions for accessing a server 108 of a third-party service provider 108 using a user's electronic credentials, for downloading data associated with the user, or the like. Each different set of instructions, in certain embodiments, comprises a location for entering a user's electronic credentials, an instruction for submitting the user's electronic credentials, one or more locations of the data associated with the user, or the like.

The hierarchy module 312, in one embodiment, may receive one or more sets of instructions from a backend server 110 (e.g., a backend verification module 104 of a backend server 110), from another user hardware computing device 102 in a peer-to-peer manner (e.g., a verification module 104 of a user hardware computing device 102), from a test module 318, or the like. The hierarchy module 312, in certain embodiments, may receive multiple different sets of instructions already in an ordered list (e.g., a global hierarchical order) based on a history of successful and/or unsuccessful uses of the different sets of instructions by different user hardware computing devices 102 and/or users, or the like. In one embodiment, the hierarchy module 312 may determine a hierarchy for and/or create an ordered list from multiple different sets of instructions for a single user (e.g., a custom or individualized hierarchy) based on a history of successful and/or unsuccessful uses of the different sets of instructions by the user (e.g., from one or more hardware computing devices 102 of the user).

The direct access module 104, in one embodiment, may iterate through an ordered list of multiple sets of instructions for accessing a server 108 of a third-party service provider 108, in the order of the list, until one of the sets of instructions is successful and the direct access module 104 is able to access and/or download data from the third-party service provider 108. The hierarchy module 312, in one embodiment, may place a most recent successfully used set of instructions at the top (e.g., as the first set to try). For example, the hierarchy module 312 for a user's hardware computing device 102 may place a set of instructions for accessing a third-party service provider 108 at the top of a list (e.g., adjusting an order of the list over time) in response to the direct access module 204 successfully accessing and/or downloading data from the third-party service provider 108 using the set of instructions. In certain embodiments, the hierarchy module 312 may receive an ordered list of multiple different sets of instructions for accessing a server 108 of a third-party service provider 108 in a first order (e.g., a global order) and may dynamically adjust and/or rearrange the different sets of instructions over time based on a single user's/hardware computing device 102's use (e.g., moving a set of instructions up in the list if access using the set of instructions is successful for the user/hardware computing device 102, moving a set of instructions down in the list if access using the set of instructions is unsuccessful for the user/hardware computing device 102, or the like).

The hierarchy module 312, in certain embodiments, may be configured to share one or more sets of instructions, an ordered list of multiple sets of instructions, or the like with a hierarchy module 312 of another user's hardware computing device 102 over a data network 106 (e.g., directly to the other user's hardware computing device 102 in a peer-to-peer manner, indirectly by way of a backend verification module 104 of a backend server 110, or the like). Different sets of instructions may be successful or unsuccessful for different users, in various embodiments, due to different account types, different account settings, different originating systems (e.g., due to a corporate acquisition or the like, different users of the same third-party service provider 108 may have one or more different settings, different access methods, or the like), system changes or upgrades, and/or another difference in accounts, services, or the like for different users of the same third-party service provider 108.

In one embodiment, the route module 314 determines whether a hardware computing device 102 of a user is available for the direct access module 204 to download data associated with the user from a server 108 of a third-party service provider 108. The route module 314, in certain embodiments, may access a server 108 of a third-party service provider 108, from a remote backend server 110, using the user's electronic credentials, to download data associated with the user from the server 108 to the remote backend server 110 in response to the route module 314 determining that the hardware computing device 102 of the user is unavailable. The route module 314, in one embodiment, provides a user one or more alerts (e.g., downloaded data from a third-party service provider 108, a recommendation or suggestion determined based on data from a third-party service provider 108, a notification or other alert based on an event or other trigger detected in data from a third-party service provider 108, or the like) on a hardware computing device 102 of the user based on the data associated with the user downloaded to the remote backend server 110.

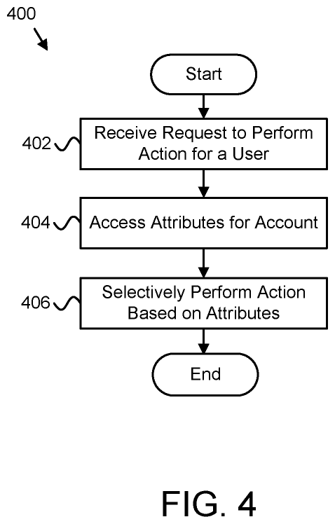

In certain embodiments, the route module 314 maintains and/or stores a list of multiple hardware computing devices 102 associated with a single user and/or account. In response to determining that one hardware computing device 102 associated with a user and/or account is unavailable (e.g., powered down, in airplane mode, not connected to the data network 106, or the like), the route module 314 may access a server 108 of a third-party service provider 108 from a different, available hardware computing device 102 of the user and/or account, may provide one or more notifications or other alerts on a different, available hardware computing device 102, or the like. The route module 314, in various embodiments as described below with regard to FIGS. 4A-4C, may dynamically route downloading of data for a user from a third-party service provider 108 between multiple hardware computing devices, such as one or more hardware computing devices 102 of the user, one or more hardware computing devices 102 of a different user, one or more backend servers 110, and/or another hardware computing device, in a secure manner.

The route module 314, in one embodiment, may alternate or rotate between multiple hardware computing devices 102, 110 (e.g., of the same user, of different users, or the like) for downloading data for the same user from a third-party service provider 108 periodically. For example, rotating and/or alternating devices 102, 110 from which data is downloaded, may decrease a likelihood that the downloading will be misinterpreted as fraudulent or improper. In another embodiment, the route module 314 may download data from the same device 102, 110 (e.g., a primary hardware computing device 102 of a user, a backend server 110, or the like), which may be authorized and/or identified by the third-party service provider 108 as a trusted device, or the like.

In one embodiment, the frequency module 316 sets a frequency with which the direct access module 204 accesses the server 108 of a third-party service provider 108. The frequency module 316, in certain embodiments, determines a frequency based on input from a remote backend server 110, which may be unaffiliated with the third-party service provider 108 being accessed, so that the remote backend server 110 (e.g., the frequency module 316 executing on the remote backend server 110) determines frequencies for a plurality of direct access modules 204 for different users and/or different hardware computing devices 102. For example, the frequency module 316 may limit a single user and/or hardware computing device 102 from accessing the same third-party service provider 108 more than an allowed threshold number of times within a time period (e.g., once every ten minutes, once every half an hour, once every hour, twice a day, three times a day, four times a day, or the like). The frequency module 316, in certain embodiments, limits an access frequency to prevent inadvertent denial of service by a third-party service provider 108, or the like.

The frequency module 316, in certain embodiments, may dynamically adjust a frequency with which a user and/or hardware computing device 102 may access a third-party service provider 108 over time. For example, the frequency module 316 may monitor access and/or downloads by multiple users (e.g., all users, available users, active users, or the like) to cap or limit a total access and/or download bandwidth for each of the different third-party service providers 108 (e.g., so as not to overwhelm any single third-party service provider 108, or the like). In this manner, in one embodiment, a user and/or hardware computing device 102 may access and/or download data with a higher frequency when fewer other users and/or hardware computing devices 102 are accessing and/or downloading data (e.g., low peak times), but may be limited to a lower cap or access frequency when more other users and/or hardware computing devices 102 are accessing and/or downloading data (e.g., high peak times).

In a further embodiment, the frequency module 316 determines a frequency based on input from a user, allowing the user to set the access frequency independently of other users and/or of a backend server 110. The frequency module 316 may provide a user interface (e.g., a GUI, CLI, API, or the like) allowing a user to set and/or adjust an access frequency for downloading data from one or more third-party service providers 108 using one or more hardware computing devices 102 (e.g., providing different settings allowing the user to set different access frequencies for different third-party service providers 108, different hardware computing devices 102 of the user, or the like).

FIG. 4 depicts one embodiment of a method 400 for transaction based fraud detection. The method 400 begins and a verification module 104 receives 402, over an application programming interface, an electronic request to perform an action for a user. For example, in various embodiments, an action may include opening a new account for a user, transferring funds and/or making a payment to an account for a user, transferring funds and/or making a payment from an account for a user, aggregating one or more transactions from an account for a user, scheduling bill-pay and/or another recurring payment from an account for a user, or the like.

A verification module 104 electronically accesses 404 one or more attributes of an account for a user (e.g., an age of an account, a balance of an account, a frequency of transactions for an account, a number of transactions for an account, a monetary amount of one or more transactions for an account, a total monetary amount of transactions for an account, an average monetary amount of transactions for an account, a date of a most recent transaction for an account, a date of an oldest deposit for an account, a date of a most recent deposit for an account, a monetary amount of a deposit for an account, a type of an account, a role of a user for an account, identity data for a user of an account, or the like). A verification module 104 selectively performs 406 the action for the user based on the one or more attributes of the account, and the method 400 ends.

FIG. 5 depicts one embodiment of a method 500 for transaction based fraud detection. The method 500 begins and a verification module 104 determines 502 whether an electronic request to perform an action for a user has been received (e.g., by monitoring an API or other interface, by receiving a notification or other indication that a request has been received, or the like).

In response to determining 502 that a request to perform an action for a user has been received, a verification module 104 electronically accesses 504 one or more attributes of an account for the user. A verification module 104 determines 506 a confidence score indicating a likelihood that the account is fraudulent based on the one or more attributes of the account. A verification module 104 provides 508 the confidence score to a client that submitted the electronic request (e.g, over the API, in a GUI, in another message, or the like).

A verification module 104 determines 510 whether the confidence score indicates fraud (e.g., satisfies a predefined fraud threshold, or the like). In response to determining 510 the confidence score does not indicate fraud, a verification module 104 performs 512 the action for the user (e.g., based on the confidence score and the one or more attributes of the account failing to indicate fraud, or the like) and the verification module 104 continues to monitor 502 for subsequent requests. In response to determining 510 the confidence score indicates fraud, a verification module 104 does not perform the requested action and continues to monitor 502 for subsequent requests.

A means for receiving, over an application programming interface, an electronic request to perform an action for a user, in various embodiments, may include one or more of a hardware computing device 102, 108, 110, a backend server 110, a verification module 104, a datapath module 112, a core processing system 122a-n, a data network 106, an API, a CLI, a GUI, a network interface, a volatile memory, a non-transitory computer readable storage medium, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware computing device, other logic hardware, an application 114, and/or other executable code stored on a computer readable storage medium. Other embodiments may include similar or equivalent means for receiving, over an application programming interface, an electronic request to perform an action for a user.

A means for electronically accessing one or more attributes of an account for a user, in various embodiments, may include one or more of a hardware computing device 102, 108, 110, a backend server 110, a verification module 104, a datapath module 112, a core processing system 122a-n, a data network 106, an API, a CLI, a GUI, a network interface, a volatile memory, a non-transitory computer readable storage medium, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware computing device, other logic hardware, an application 114, and/or other executable code stored on a computer readable storage medium. Other embodiments may include similar or equivalent means for electronically accessing one or more attributes of an account for a user.

A means for selectively performing an action for a user based on one or more attributes of an account, in various embodiments, may include one or more of a hardware computing device 102, 108, 110, a backend server 110, a verification module 104, a datapath module 112, a core processing system 122a-n, a data network 106, an API, a CLI, a GUI, a network interface, a volatile memory, a non-transitory computer readable storage medium, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a hardware appliance or other hardware computing device, other logic hardware, an application 114, and/or other executable code stored on a computer readable storage medium. Other embodiments may include similar or equivalent means for selectively performing an action for a user based on one or more attributes of an account.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor;
a memory that stores code executable by the processor to:
receive, over an application programming interface, an electronic request to perform an action for a user;
electronically access one or more attributes of an account for the user; and
selectively perform the action for the user based on the one or more attributes of the account.

2. The apparatus of claim 1, wherein the code is further executable by the processor to:
determine a confidence score indicating a likelihood that the account is fraudulent based on the one or more attributes of the account; and
provide the confidence score, over the application programming interface, to a client that submitted the electronic request.

3. The apparatus of claim 1, wherein the one or more attributes comprise an age of the account.

4. The apparatus of claim 1, wherein the one or more attributes comprise a balance of the account.

5. The apparatus of claim 1, wherein the one or more attributes comprise one or more of a frequency of transactions for the account, a number of transactions for the account, a monetary amount of one or more transactions for the account, a total monetary amount of transactions for the account, an average monetary amount of transactions for the account, and a date of a most recent transaction for the account.

6. The apparatus of claim 1, wherein the one or more attributes comprise a date of an oldest deposit for the account, a date of a most recent deposit for the account, and a monetary amount of a deposit for the account.

7. The apparatus of claim 1, wherein the one or more attributes comprise a type of the account and a role of the user for the account.

8. The apparatus of claim 1, wherein the one or more attributes are electronically accessed over a data network using an electronic interface of a third-party service provider holding the account for the user.

9. The apparatus of claim 1, wherein the one or more attributes are received over the application programming interface from a client that submitted the electronic request.

10. The apparatus of claim 1, wherein the one or more attributes comprise identity data for the user.

11. The apparatus of claim 1, wherein the code is further executable by the processor to determine whether the account is a new account and the one or more attributes comprise identity data for the user in response to a determination that the account is new.

12. A method, comprising:
receiving, over an application programming interface, an electronic request to perform an action for a user;
electronically accessing one or more attributes of an account for the user; and
selectively performing the action for the user based on the one or more attributes of the account.

13. The method of claim 12, further comprising:
determining a confidence score indicating a likelihood that the account is fraudulent based on the one or more attributes of the account; and
providing the confidence score, over the application programming interface, to a client that submitted the electronic request.

14. The method of claim 12, wherein the one or more attributes comprise one or more of an age of the account, a balance of the account, a frequency of transactions for the account, a number of transactions for the account, a monetary amount of one or more transactions for the account, a total monetary amount of transactions for the account, an average monetary amount of transactions for the account, and a date of a most recent transaction for the account.

15. The method of claim 12, wherein the one or more attributes comprise a date of an oldest deposit for the account, a date of a most recent deposit for the account, and a monetary amount of a deposit for the account.

16. The method of claim 12, wherein the one or more attributes comprise a type of the account and a role of the user for the account.

17. The method of claim 12, wherein the one or more attributes are electronically accessed over a data network using an electronic interface of a third-party service provider holding the account for the user.

18. The method of claim 12, wherein the one or more attributes are received over the application programming interface from a client that submitted the electronic request.

19. The method of claim 12, further comprising determining whether the account is a new account and the one or more attributes comprise identity data for the user in response to a determination that the account is new.

20. An apparatus, comprising:
means for receiving, over an application programming interface, an electronic request to perform an action for a user;
means for electronically accessing one or more attributes of an account for the user; and
means for selectively performing the action for the user based on the one or more attributes of the account.
